(19) United States
(12) Patent Application Publication
(10) Pub. No.: US 2004/0045092 A1
(43) Pub. Date: Mar. 11, 2004

(54) Abrasion resistant leather

(76) Inventor: Darryl Miles Cassingham, Queensland (AU)

Correspondence Address: KENYON & KENYON, ONE BROADWAY, NEW YORK, NY, 10004, US

(21) Appl. No.: 10/381,728

(22) PCT Filed: Sep. 27, 2001
(86) PCT No.: PCT/GB01/04348

(30) Foreign Application Priority Data
Sep. 27, 2000 (GB) 0023632.3

(51) Int. Cl. C14C 1/00

(52) U.S. Cl. 8/94.15

(57) ABSTRACT

A leather is provided with enhanced abrasion resistance and improved lubricity properties by impregnating with a ceramic material of globular or generally spherical form. The leather so produced may be used in clothing, footwear, gloves and leather goods.

This invention relates to abrasion resistant leather and to methods for producing such leather.

There are many applications where an abrasion resistant leather is required for example in footwear, clothing, glove and leathergoods.

It is known to apply an abrasion resistant treatment to leather in which a ceramic material in the form of a fine powder of plate-like particles is applied with the aim of encasing the microscopic fibrils which make up the leather. We have found however that there can be difficulties in applying this material through a substantial thickness of the leather. Also the treatment can affect the feel of the leather in some applications making it feel stiff.

Accordingly, in one aspect, this invention provides an abrasion resistant leather, comprising leather impregnated with a particulate ceramic material in globular or generally spherical form.

Preferably the leather is treated with an offer of between 1% and 15% by weight of ceramic material, and more preferably between 5% and 10% especially between 2% and 6% by weight ceramic material.

The ceramic particles may be solid or hollow. They may be of silica-alumina ceramic, or soda-lime-borosilicate glass or an alkali-alumino silicate ceramic. The particle size is preferably from 1-300 μm.

We have found surprisingly that presenting the ceramic material in spherical or globular form considerably assists its permeation into the thickness of the leather so that a more uniform impregnation is possible, such that the leather has good wear resistance throughout its thickness. Another benefit provided by the use of such material is the feature that the globular or spherical material acts as a dry lubricant, thus providing a good feel to the leather.

In another aspect, this invention provides a method of producing an abrasion resistant, preferably tanned, leather which comprises introducing (preferably after tanning) into the structure of leather during processing a particulate ceramic material in globular or generally spherical form.

The ceramic material may be introduced into the leather by mixing with a re-tanning agent whereby particles of the ceramic material are trapped in the internal fibre matrix of the leather, thereby providing abrasion resistance and internally lubricating the leather. The re-tanning agent is preferably a syntan. Examples of suitable syntans are formaldehyde condensates and resins based on acrylic, styrene, maleic anhydride, etc. and modified aldehydes such as glutaraldehydes or aldehyde compounds containing two or more aldehyde groups and compositions or mixtures containing one or more of the aforesaid.

Preferably, the ceramic material is dispersed in the leather by means of a syntan or fat-liquor. In this case the syntan or fat-liquor is preferably offered to the leather in an amount equal to from 1% to 10% by weight of the dry leather, and more preferably between 2% to 6% thereof.

Optionally, an amount of fat-liquor may be added further to increase softness, preferably in an amount between 10% and 30% of the dry weight of the leather. This offer of fat-liquor may be additional to an offer added as above to disperse the ceramic material.

The mixture of the ceramic material and syntan or fat-liquor is preferably mixed with water and added substantially at the same time as the further amount of fat-liquor (if provided). The mixture of the ceramic material and syntan or fat-liquor, together with the further fat-liquor (if provided) is preferably added to a drum or other processing vessel containing the leather and an amount of water. The amount of water may be typically 500% by weight of the combined weights of the ceramic material and syntan or fat-liquor, and the further fat-liquor (if provided).

The leather is preferably subjected to drumming and/or agitation at a solution temperature of around 50° C. The pH range is preferably between 5.0 and 6.7. The drumming or agitation is preferably carried out for a period of 30 to 60 typically about 45 minutes.

At the end of this period, formic acid or another suitable pH reducing fixative may be added and the leather may be subjected to further drumming and/or agitation to complete the process. The fixative lowers the pH of the solution and causes fixation of the fat to the leather fibres.

In another aspect, this invention provides a method of producing an abrasion resistant leather which comprises the following steps:

introducing the leather into a treatment vessel such as a rotatable drum,

introducing water to the vessel,

introducing into the vessel a particulate ceramic material in globular or generally spherical form, together with water and a syntan or fat-liquor (in any order or simultaneously),

optionally adding a further amount of fat-liquor;

subjecting the vessel to rotation and/or agitation for a period of time sufficient to cause an amount of the ceramic material to be impregnated into the internal fibre structure of the leather,

introducing into said vessel a pH reducing fixative agent such as formic acid,

draining the drum of liquid contents, and

rinsing the leather.

The invention also extends to articles made wholly or partially of leather treated in accordance with this invention. Thus the leather so treated may be used in gloves, footwear, clothing, leathergoods such as suitcases, wallets, straps, etc, upholstery, saddlery, machinery, and in any other applications where abrasion resistant leather is required.

The term “globular” is used herein to define generally rounded particles such as ovoid or ellipsoid. The term “leather” is for convenience used to describe a pelt, hide or skin at any stage during the leather making process.

Whilst the invention has been described above it extends to any inventive combination of the features set out above or in the following description.

A non-limiting embodiment of the invention will now be described by way of example only.

### EXAMPLE

A batch of previously tanned skins (using a conventional tanning process such as chrome tanning) is introduced into a treatment drum, together with an amount of treatment water. Ceramic microspheres such as those marketed as “G” or “W” series Zeeospheres Microspheres from 3M Speciality Additives are offered to the leather at an amount of between 1% and 15% of the weight of the dry leather. The ceramic microspheres are pre-mixed with an amount of an syntan or a fat-liquor, for dispersing the microspheres through the leather matrix, at an amount equal to between 1% and 10% of the weight of the dry leather. If required, an amount of fat-liquor is added to further increase softness at a rate of between 10% and 30% of the dry weight of the leather. The microsphere and syntan/fat-liquor mixture, and the further fat-liquor (where used) are mixed with water at a ratio of 4:1 (water:fat-liquor) at 60° C., and added at the same time as the microsphere suspension which is added with water at 60° C., in the ratio 4:1 (water:suspension). The mixture is then added to the drum which contains 500% (by weight) of water at 50° C. and typically at a pH between 5.0 and 6.7. The leather and mixtures are drummed for typically 45 minutes, after which 2.5% (by weight) of formic acid is added and the drumming is continued for another period. At this point the ceramic microspheres have been distributed and trapped between the internal leather fibres, producing a resultant product that is abrasion resistant with a lubricated feel due to the distributed ceramic material. Where added, the further fat-liquor component contributes additional softness and suppleness to the product.

The product so obtained exhibited increased abrasion resistance, and further can be dyed into a shade as the ceramic material does not significantly discolour the leather or inhibit absorption of dye.

The leather so produced may be used for a wide range of applications such as gloves (for example sports gloves, outdoor gloves for climbing, military gloves), articles of footwear (for example soccer boots and walking boots), articles of clothing, articles of furniture (including those upholstered in leather or those employing leather structurally), leathergoods and sports equipment (for example balls, such as footballs and racquets and bats and other equipment employing leather as grips or in other ways). In each of these applications the article may in general be made wholly or partly of leather, and the part or parts that are of leather may themselves be wholly or partly of leather of the invention. In general, goods employing leather may use leather of the invention where enhanced resistance to abrasion is required.

1. A leather impregnated with a particulate ceramic material in globular or generally spherical form.

2. A leather according to claim 1, wherein said ceramic material is selected from the group comprising silica alumina ceramic, soda lime borosilicate glass and alkali alumino silicate ceramic.

3. A leather according to claim 1 or claim 2, wherein said ceramic material has a particle size distribution in the range of from 1-300 μm.

4. A leather according to claim 1 or claim 2, wherein the leather is treated with an offer of between 1% and 15% by weight ceramic material.

5. A method of producing an abrasion resistant leather which comprises introducing into the structure of leather a particulate ceramic material in globular or generally spherical form.

6. A method according to claim 5, wherein said ceramic material is introduced into the leather by mixing with a re-tanning agent whereby said particulate ceramic material is trapped in the internal fibre matrix of the leather.

7. A method according to claim 5 or 6, wherein said ceramic material is dispersed in the leather by means of a syntan or fat-liquor.

8. A method according to claim 5, 6 or 7, wherein a mixture of the ceramic material with a syntan and/or fat-liquor is mixed with water and the resulting mixture in added to the leather at substantially the same time as a further amount of fat-liquor.

9. A method according to any of claims 5 to 8, wherein the leather together with the ceramic material is subjected to drumming and/or agitation, then a pH reducing fixative is added and the leather optionally then subjected to further drumming and/or agitation.

10. A method according to any of claims 5 to 9 which comprises:
introducing the leather into a treatment vessel,
introducing water into the vessel,
introducing into the vessel a particulate ceramic material of globular or generally spherical form, together with water and a syntan or fat-liquor,
optionally adding a further amount of fat-liquor,
subjecting the vessel to rotation and/or agitation for a period of time sufficient to cause an amount of the ceramic material to be impregnated into the internal fibre structure of the leather,
introducing into said vessel a pH reducing fixative agent,
draining the drum of liquid contents, and
rinsing the leather.

11. A leather treated in accordance with the method of any of claims 5 to 10.

12. A glove, an article of footwear, an article of clothing, an article of furniture, leathergoods or sports equipment made wholly or partially of a leather according to any claims 1 to 7 or 11.
